(19) United States
(12) Patent Application Publication
(10) Pub. No.: US 2004/0063843 A1
(43) Pub. Date: Apr. 1, 2004

(54) Coating solutions

(75) Inventors: George A. Shia, Amherst, NY (US); Rajiv R. Singh, Getzville, NY (US)

Correspondence Address: Honeywell International, Inc., 101 Columbia Road, P.O. Box 2245, Morristown, NJ, 07962-2245, US

(73) Assignee: Honeywell International, Inc., Morristown, NJ (US)

(21) Appl. No.: 10/622,523

(22) Filed: Jul. 18, 2003

Related U.S. Application Data
(60) Provisional application No. 60/397,057, filed on Jul. 19, 2002.

(51) Int. Cl. B05D 3/12; B05D 3/02; B05D 1/18; C08K 5/02

(52) U.S. Cl. 524/462; 427/385.5; 427/240; 427/430.1

(57) ABSTRACT

Compositions comprising: (i) a coating solvent comprising a liquid carrier, and at least one fluorocarbon surface tension-reducing agent; and (ii) a coating moiety dissolved therein are described. Also described is a method of using the compositions to solution coat a surface.

### REFERENCE TO RELATED APPLICATIONS

This application is based on and claims the priority of U.S. Provisional Application No. 60/397,057 filed Jul. 19, 2002, which is incorporated herein in its entirety by reference.

### BACKGROUND OF THE INVENTION

In a solution coating process, a layer of material is applied to a surface from a solution (coating solution) comprising the material to be applied to the surface (coating moiety). Generally, the coating solution consists of a coating moiety and volatile components (volatiles) which do not form part of the coating. The volatiles generally comprise a solvent (liquid carrier) for the coating moiety and may comprise as well other components which impart various desirable properties to the coating solution and/or provide for the formation of an even layer of coating moiety.

A coating moiety can comprise any compound or mixture which remains on the surface of a coated object after completion of the coating process. The coating moiety can be chemically bonded to the surface, for example, by a reaction with one or more surface species, or it may be adhered to the surface by, for example, electrostatic forces, as for a physisorbed layer. Examples of coating moieties which may be applied to a surface include a protective layer covering the surface to prevent mechanical damage to the surface and a light reactive dye layer, for example, such as is deposited on a disk during the manufacture of a writable compact disk.

A solution coating process is carried out by applying an even layer of coating solution to the surface to be coated and evaporating or otherwise removing therefrom the volatiles. To successfully provide an even coating by a solution coating process, the coating moiety must have an affinity for the surface to which it is applied. The carrier must be chosen to have sufficient ability to solvate the coating moiety so that an even layer can be formed during volatiles evaporation and a coating moiety layer of desired thickness can be deposited. It will be appreciated that there are many techniques known in the art for carrying out a solution coating process, an example of which is spin coating.

An example of the use of spin-coating to apply a layer of a coating moiety to a surface can be found in one step of a process providing data storage discs for optically recording digital information (optical recording media). Such discs employ, as the light-reactive component of the recording media, a layer comprising a light-reactive dye on one face of a transparent disc. A suitable dye layer can be prepared by applying a solution comprising the dye (coating solution) to one face of the disc while it is spinning on an axis of rotation perpendicular to the face, thereby evenly distributing the coating solution. While spinning is continued, the volatile constituents of the coating solution are evaporated from the layer of coating solution, leaving behind a uniform dye layer adhered to the disc face.

In the spin coating application of a dye layer to form the recording material on optical recording media, the factors governing formation of a suitably uniform dye layer are art-recognized, for example, those disclosed in U.S. Pat. Nos. 6,383,722 to Shinkai and 5,855,979 to Umehara.

In general, an even dye layer is formed from an even application of the coating solution to the surface to be coated, and proper perturbation of the incipient dye layer during evaporation of the volatile constituents of the coating solution. Formation of an even layer of coating solution is generally accomplished by application of an excess of coating solution to the surface of the disc while it is spinning at an initial rate. The angular momentum distributes the coating solution across the disc, establishes an even layer of coating solution, and throws the excess solution off the disc.

To maintain a uniform coating while the solvent evaporates, the rotation rate is increased in a series of steps as evaporation proceeds. Throughout the spin coating operation, the disc is in an environment having a temperature suitable to evaporate the liquid carrier of the coating solution.

Generally, in a spin-coating process, the initial rotational speed of the disc is selected to give the desired thickness of coating solution retained on the disc after application of coating solution. As the solvent evaporates, the timing and amount of angular velocity increase is determined by the thickness of the coating desired and the properties of the coating solution, for example, the concentration of the dye dissolved therein and the volatility of the liquid carrier.

It will be appreciated that in the process of producing optical recording discs additional layers, for example a reflecting layer and a protecting layer, are added to produce a finished disc, as is detailed in the publications referenced above.

The properties of the liquid constituents of a coating solution which dissolve the coating moiety (liquid carrier) can influence the uniformity of the finished coating. It will be appreciated that in selecting a liquid carrier, factors which must be taken into account include the amount of coating moiety which can be dissolved in the liquid carrier, the ability of a coating solution incorporating the liquid carrier to “wet” the surface to be coated and the volatility of the liquid carrier. Also taken into account should be the tendency of any of the components of the liquid carrier to swell or locally dissolve the surface of the substrate to be coated. To achieve a uniform coating, no component of the coating solution should be able to swell or dissolve the surface to be coated.

It will also be appreciated that as the concentration of coating moiety in the coating solution is increased, thicker layers of coating moiety can be formed. It will also be appreciated that as the concentration of a coating moiety approaches saturation of the coating solution, a small amount of evaporation of the liquid carrier will cause solid coating moiety to precipitate from the solution, which can result in non-uniform coatings.

It is desirable that the liquid carrier is not so volatile that the coating moiety precipitates from the coating solvent during storage or during formation of a coating solution layer on a surface to be coated. However, the liquid carrier must be sufficiently volatile that it can be removed in a short time after the coating solution has been distributed on the surface to be coated, minimizing the per-piece cycle time. The latter is an important consideration in mass-production coating operations.

As has been shown in U.S. Pat. No. 6,383,722, (the '722 patent) the surface tension exhibited by the coating solution effects the volume of solution which must be applied to a surface to be coated to produce an even layer of coating solution on the surface. As the surface tension of the coating solution is reduced, it “wets” the surface to be coated increasingly well, requiring less of an excess of coating solution to be applied to the surface to insure formation of a uniform coating solution layer. Accordingly, as less excess coating solution is needed, less solution is “spun off” and “wasted” during this part of the process. Additionally, for a given initial spinning rate, the lower surface tension coating solution spreads out over the surface to be coated more rapidly, which also reduces the per-piece cycle time of a coating operation. In the preparation of optical storage media, solutions which wet the surface to be coated must be chosen so that they do not dissolve or otherwise swell or chemically attack the surface, as such surface damage may result in poor optical performance during data writing or reading operations.

Other considerations when applying a coating of a coating moiety to a surface include the ability of the coating solution to flow into and fill in patterned surface features, for example, “wells”, “pits”, and “grooves” provided in the surface, with coating moiety, thereby providing a “patterned” surface coating. An example of a patterned surface feature to be filled in by a coating moiety, described in the '722 patent, is a tracking groove on a writable CD.

It will be appreciated that the above described considerations can apply to a variety of solution coating processes. What is needed is a coating solution which has: a) low surface tension on a variety of surfaces; b) high capacity for a coating moiety solute; c) good “groove-filling” properties and d) sufficient volatility so that there is provided a coating solution that minimizes the amount of time and volume of coating solution required to coat a surface.

### SUMMARY OF THE INVENTION

In accordance with the present invention there is provided a coating solution comprising: (i) a coating solvent comprising a liquid carrier, and at least one surface tension-reducing fluorocarbon miscible therewith; and (ii) a coating moiety dissolved therein.

Also in accordance with the present invention there is provided a method of applying to a surface a layer comprising a coating moiety, by contacting the surface to be coated with a coating composition of the present invention comprising a coating moiety, a liquid carrier, and at least one fluorocarbon surface tension-reducing moiety.

In preferred form, the liquid carrier of the coating composition comprises one or more fluorinated alcohols selected from the group consisting of alcohols having from about 3 to about 7 carbon atoms and from about 1 to about 13 fluorine atoms. Most preferred are one or more liquid carriers selected from 2,2,3,3-tetrafluoro-1-propanol and 2,2,3,3,4,4,5,5-octafluoro-1-pentanol. In preferred form, the surface tension-reducing fluorocarbon of the coating composition comprises one or more fluorocarbons selected from 1,1,1,3,3 pentafluoropropane (HFC245fa) and 1,1,1,2,2 pentafluorobutane (HFC365mfc). Preferred compositions comprise: (i) a coating solvent which comprises up to about 90 volume percent (Vol. %) of a liquid carrier blended with from about 1 Vol. % to about 75 Vol. % of a surface tension-reducing fluorocarbon; and (ii) dissolved therein up to about 10 wt. % of a coating moiety.

Other features of the present invention will be pointed out in the following description and claims, which disclose, by way of example, the principles of the invention and the best methods which have been presently contemplated for carrying them out.

### BRIEF DESCRIPTION OF DRAWINGS

FIG. 1 is a graphic representation of evaporation rates of various constituents used in coating compositions according to the present invention.

### DETAILED DESCRIPTION OF THE INVENTION

Many surfaces have a layer of a moiety applied to them by evenly coating the surface with a solution comprising the moiety and evaporating from that coating the liquid carrier of the coating solution in such a manner that the coating moiety is left behind as a substantially uniform film evenly covering the surface.

Examples of such coating processes include, but are not limited to, application of lubricant to a magnetic hard disc by dip coating and application by spin coating of a photo-active dye to a surface of an optically transparent disc in the production of optical storage media for storing digital information. Examples of optical storage media are commercially available DVD-R and CD-R data storage discs.

Spin coating involves, in its simplest conceptualization, application of a coating solution to a surface which has an angular velocity, permitting a thin, uniform layer of the coating solution to be distributed on the surface thereby, and evaporation of the volatile components of the coating solution (volatiles) to leave behind a layer of a coating moiety on the surface.

In a spin coating process, generally, the angular velocity of the coated surface is increased during the evaporation of volatiles to ensure uniformity of the layer of coating moiety forming on the surface.

As described above, spin coating can be exemplified by the application of a dye layer as the light-reactive component in the production of optically writable data storage discs (optical recording media).

It is known in the art, for example, U.S. Pat. No. 6,383,722 to Shinkai, that uniformity of the dye film provided by spin coating of dyes suitable for use in optical recording media is improved by the addition of an alkyl-alcohol, for example, methanol, ethanol, and propanol, to the liquid carrier used in formulating a coating solution. Coating solutions which include such an alcohol constituent have low volatility and are only slowly converted to a dye film because the volatiles in the coating solution evaporate relatively slowly.

In one embodiment of the present invention, there is provided a coating solution formulation which demonstrates the same or better wetability on a surface to be coated and displays as well increased volatility over prior art coating solution formulations.

It will be appreciated that the coating solution of the present development may be used to apply a coating to a variety of surfaces for example, metal, plastic, and glass. In the above described example, the production of optical recording media, the surface to be coated is typically a thermo-plastic resin, for example, polycarbonate, acrylic, amorphous polyolefin, polystyrene and the like, and coating solutions of the present development may be formulated which are suitable for applying a dye coating to those surfaces.

Coating solutions of the present development comprise a coating moiety dissolved in a coating solvent which comprises a miscible mixture of a liquid carrier, and at least one surface tension-reducing fluorocarbon.

Coating moieties suitable for use in coating solutions of the present development are selected from chemical species which exhibit an affinity, whether by chemisorption or physisorption, for the surface to be coated, are soluble to a level of at least some measurable degree in the surface tension-reducing fluorocarbon(s) selected for the formulation, and are soluble to at least about 0.1 wt. % in a mixture comprising the surface tension-reducing fluorocarbon and a liquid carrier miscible therewith, thereby permitting suitable concentrations of the coating moiety to be dissolved in the coating solution.

Although coating moieties suitable for use in coating solutions of the present development can be found which pertain to a wide range of coating applications, the present invention is exemplified by the provision of a coating solution for providing a light-reactive dye layer, the active recording material in optical recording media, as mentioned above. An example of a class of suitable light reactive dyes used in optical recording media are the cyanine dyes, for example, S0628 from Organica, which has the structure shown in Structure 1 below.

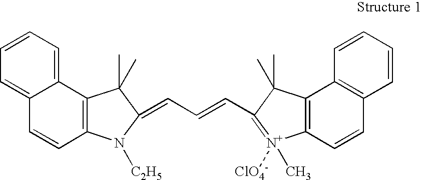

Other examples of cyanine dyes include SO 611 and SO 627 obtained from FEW chemicals.

Other examples of dyes suitable for use in optical recording media include rhodamine dyes, phthalacyanine dyes, formazan dyes, triphenylmethane dyes, azo dyes, and azo metal dyes. Specific examples of these and still other suitable dyes are art-recognized, and described in, for example, U.S. Pat. Nos. 6,383,722 to Shinkai, 5,855,979 to Vomehara, and 5,693,396 to Misawa. Cyanine dyes are preferred in coating solutions of the present development when the solutions are used in the formation of a light-reactive dye layer in optical recording media.

The coating moiety of a coating solution of the present invention can comprise for example, one of the dyes described above, or a mixture of one or more dyes. Coating solutions may also optionally include additional constituents, for example, a light stabilizer, for example, IRG 022 quencher from HBL (Japan), a binder, a thermal decomposition promoter, a dispersant, and other constituents as are known in the art.

The coating solution is made by dissolving the coating moiety in a coating solvent. The coating solvent comprises a miscible blend of one or more liquid carriers and one or more surface tension-reducing fluorocarbon(s). The liquid carrier of a coating solution is largely responsible for the solvent power of the coating solvent for the coating moiety. Suitable liquid carriers are known in the art, for example, keto-alcohols such as, 4-hydroxy-4-methyl-2-pentanone, ketones, alkyl-alcohols, hydrocarbons, esters, ethers, for example, dibutyl ether, “cellosolve”, halo-alkyls, halo-alcohols, and the like. Miscible mixtures of two or more of the foregoing may be used.

Factors considered in selecting a liquid carrier include the solubility of the coating moiety in the carrier, miscibility of any other liquid components of the coating solution in the liquid carrier, ability of the liquid carrier to wet the surface to be coated, inertness of the liquid carrier to the other constituents of the coating solution and the surface to be coated, and the ability of the liquid carrier to be evaporated from the coating solution after application of the solution to a surface to be coated.

Two liquid carriers which exemplify those suitable for use in the present development are 2,2,3,3-tetrafluoro-1-propanol (herein tetrafluoropropanol) and 2,2,3,3,4,4,5,5-octafluoro-1-pentanol (herein octafluoropentanol). These carriers are widely used in the formation of a dye layer in optical storage media because, in general, the dyes used for this purpose are highly soluble in them. It will be appreciated that there are numerous fluorinated alcohols which can be also employed as liquid carriers in a coating solution of the present invention as well as mixtures of these various alcohols. Additionally, the optional constituents should also be soluble in the liquid carrier.

In a coating solution of the present invention, an essential component of the solution is a fluorocarbon surface tension-reducing agent. Fluorocarbon surface tension-reducing agents which are suitable for use in the present invention are those that are more volatile than the liquid carrier used to dissolve the coating moiety.

Although volatility of a material is related to its vapor pressure in the environment in which it is located, a crude approximation of volatility can be ascertained from the boiling point of a material. Typically, liquid carriers used in spin coating applications, have boiling points below 200° C. and above 50° C., and volatility such that it takes more than 100 minutes for ½ of the weight of the carrier to evaporate under ambient temperature and pressure conditions from a vessel having an opening area/volume ratio which is large, for example, a vessel which is a 50 ml petri dish. Suitable fluorocarbon surface tension-reducing agents are readily miscible with liquid carriers such as those exemplified above, have boiling points typically less than 50° C. and volatility such that ½ the weight of a sample of the fluorocarbon surface tension-reducing agent evaporates in less than half the time required for the liquid carrier under the volatility test conditions described above.

In general, hydrocarbons with some or all of their hydrogen atoms replaced by fluorine atoms and having from about 3 to about 8 carbon atoms and from about 1 to about 18 fluorine atoms have the vapor pressure characteristics described above, and thus are suitable for use as volatile surface tension-reducing agents in coating solution formulations of the present development. Examples of these fluorocarbons are, 1,1,1,3,3-pentafluoropropane (HFC245fa) and 1,1,1,2,2-pentafluorobutane (HFC365mfc).

Fluorocarbons suitable for use as surface tension-reducing agents in compositions of the present development are aliphatic compounds of linear, branched, or cyclic structure, and may be saturated or unsaturated. They have at least one fluorine atom bonded to at least one carbon atom in their structure and may be a hydrofluorocarbon or a completely fluorine substituted fluorocarbon. An example of a linear fluorocarbon suitable for use as a surface tension-reducing agent is 1,1,1,3,3-pentafluoropropane. An example of a branched fluorocarbon suitable for use as a surface tension-reducing agent is (CF₃)₃CH, and of a suitable cyclic fluorocarbon, 1,2,2,3,3,4,4,5,5,6,6 undecafluorocyclohexane. Examples of suitable unsaturated fluorocarbons are 3,3,4,4,4-pentafluoro-2-methyl-1-butene and 2,3,3,4,4-pentafluoro-1-methyl-cyclobutene. Other fluorocarbons which can be used as surface-tension reducing agents in compositions of the present invention are well known and described in, for example, “Aliphatic Fluorine Compounds” by A. M. Lovelace et. al. (Rheinhold, 1958). It will be appreciated that this is not an exhaustive list. Fluorocarbons are well known in the art as, for example, blowing agents for polymer foams, solvents and fire extinguishents. It will be appreciated that numerous of the known fluorocarbons can be employed as the volatile surface tension-reducing agents in formulations of the present invention, as well as mixtures of the various fluorocarbons. In general, fluorocarbons are capable of acting to reduce the surface tension of alcohol-based solvents, for example, tetrafluoropropanol and octafluoropentanol, on plastic surfaces, for example the resins exemplified above.

Thus, with regard to a coating solution for the provision of a light-reactive dye layer in optical storage media, wherein the coating solution comprises as a coating moiety one or more light reactive dyes which are dissolved in a coating solvent comprising one or more liquid carriers and optional constituents, for example, a binder, a dispersant, and a stabilizer, the inventors have found that the addition of a fluorocarbon as a surface tension-reducing agent improves the ability of the coating solution to wet the surface to be coated and increases the volatility of the liquid carrier.

The coating solutions of the present development may be prepared by any known means of blending volatile materials. Conveniently, a coating solution can be prepared by combining a weighted amount of coating moiety, for example, a dye material and a stabilizer material, and a measured volume of a solvent, for example, a fluorinated alcohol, in a vessel with stirring until the solid components have dissolved, follow by addition of a measured volume the volatile fluorocarbon surface tension-reducing agent to the solution.

By way of illustration, a coating solution of the present development will be prepared by adding to a volume of tetrafluoropropanol, a weighed amount of cyanine dye SO 619 (FEW Chemicals) and a weighed amount of IRG 022 quencher (Organica) with stirring until the dye and stabilizer are dissolved, and blending into the solution a measured amount of 1,1,1,3,3-pentafluoropropane.

In coating solutions of the present development, typically, the coating moiety will be present in an amount of about 0.1 to about 10% by weight of the liquid constituents present, and preferable in the range of about 0.5 to about 5.0 wt % of the liquid constituents of the coating solution.

Other ratios may be employed, as are warranted by the solubility, coating, parameters, and requirements of the coating to be applied.

Alternatively, the coating solution is prepared by blending a volumetric ratio of the liquid carrier and the volatile fluorocarbon surface tension-reducing agent. In general, a coating solution of the present invention will comprise up to about 75 vol. % of the volatile fluorocarbon surface tension-reducing agent. Various factors, described above, will dictate the ratio of the two, and, in some cases, for example, when a coating moiety is readily soluble in a volatile fluorocarbon surface tension-reducing agent, the ratios described above may lie outside of that range.

A coating solution of the present development can be utilized in a spin coating apparatus which conveys the coating solution by pumping, spraying, or gravity flow.

The following examples are presented for the purpose of illustrating the forgoing description and are not meant to limit the scope of the claimed invention.

### EXAMPLES

The first group of examples illustrates, in a coating solvent of the present development, the solubility of two cyanine dyes typical of those used to produce optical digital recording media, and compares it with the solubility of those dyes in constituents of the coating solvent.

### Examples 1-4

### Solubility of Cyanine Dyes

Coating solvent was prepared by blending in a vessel a measured volume of a liquid carrier (tetrafluoropropanol) and as a surface tension-reducing agent 1,1,1,3,3-pentafluoropropane (HFC245fa) to give a solvent having the constituent volumetric ratios shown in Table I, below.

Solubility was determined by adding dye powder slowly to a weighed 100 ml aliquot of the coating solvent in a vessel. The solvent was stirred to dissolve the dye. When no more dye would dissolve, the dye addition was stopped and the solvent reweighed to determine the amount of dye that had been dissolved in the solvent.

The data in Table 1 (below) show that even with high levels of the fluorocarbon surface tension-reducing agent present, adequate amounts of dye to prepare dye layers can be dissolved in a coating solvent of the present development.

TABLE I

| | | Dye A * | Dye B** |
|---|---|---|---|
| Example | | Solubility | Solubility |
| Number | Composition | (g/100 ml) | (g/100 ml) |
| Comparative | 100 vol. % Tetrafluoropropanol | 10.7 | 11.3 |
| Example # 1 | | | |
| Example # 2 | 75 vol. % tetrafluoropropanol / | 6.7 | 7.5 |
| | 25 vol. % 1,1,1,3,3- | | |
| | pentafluoropropane | | |
| Example # 2 | 50 vol. % tetrafluoropropanol / | 1.2 | 2.0 |
| | 50 vol. % 1,1,1,3,3- | | |
| | pentafluoropropane | | |
| Example # 3 | 75 vol. % diacetone alcohol / | 1.2 | 0.4 |
| | 25 vol. % 1,1,1,3,3- | | |
| | pentafluoropropane | | |
| Example # 4 | 50 vol. % diacetone alcohol / | 0.8 | 0.4 |
| | 50 vol. % 1,1,1,3,3- | | |
| | pentafluoropropane | | |

* Cyanine Dye SO619 from FEW Chemicals.
**Cyanine Dye SO627 from FEW Chemicals.

The second group of examples illustrates the rate of evaporation of selected coating solvent compositions of the present development and compares them with those of the neat liquid carrier component of each composition.

### Examples 5-7

### Evaporation Rates of Coating Solvent Compositions

Coating solvents were prepared by blending in a vessel a measured volume of liquid carrier and of a surface tension-reducing agent to give the coating solvents of the composition shown in Table 2.

TABLE 2

| | | Surface tension |
|---|---|---|
| | | reducing agent* |
| Example # | Liquid Carrier / Vol. % | Vol. % |
| Comparative Example # | dibutyl ether / 100% | X |
| 2 | | |
| Comparative Example # | diacetone alcohol / 100% | X |
| 3 | | |
| Comparative Example # | Tetrafluoropropanol / 100% | X |
| 4 | | |
| Example # 5 | dibutyl ether / 50% | 50% |
| Example # 6 | diacetone alcohol / 50% | 50% |
| Example # 7 | Tetrafluoropropanol / 50% | 50% |

*1,1,1,3,3-pentafluropropane [HFC245fa]

Evaporation rates were tested by dispensing 20 ml of the coating solvent quickly in a pre-weighed 50 ml Petri dish placed atop an electronic balance. The weight loss was measured as a function of time

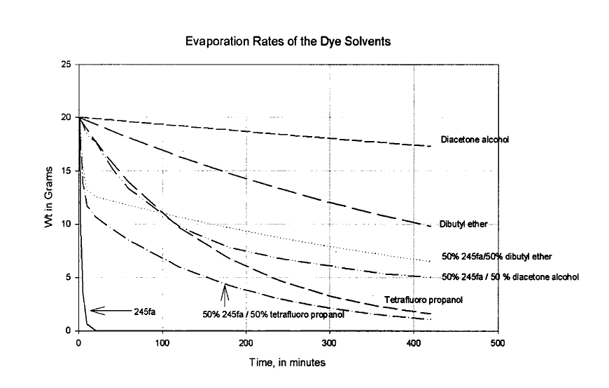

The evaporation rates of the various compositions are presented in FIG. 1. These results demonstrate that in all cases the addition of the surface tension-reducing agent (HFC245fa) increases evaporation rates over the liquid carrier alone.

The next set of examples demonstrates the surface tension on a polycarbonate surface displayed by coating solvent compositions of the present development and compares it with that of a liquid carrier.

### Examples 8-11

### Surface Tension Measurement of Coating Solvents of the Present Development

Samples of coating solution (Examples 8, 9, 10, and 11) were prepared by blending in a vessel a measured volume of a liquid carrier (tetrafluoropropanol) and a fluorocarbon surface tension-reducing agent (1,1,1,3,3-pentafluoropropane, HFC245fa) to give the Vol. % compositions indicated in Table 3, below.

Surface tension was measured using the Nouy ring method and a Kruss Instrument Model K 10 ST.

In a typical determination, a 20 ml aliquot of the liquid to be tested was placed in the instrument and the surface tension was measured by the published procedure described above. Measurements were carried out for neat tetrafluropropanol (a liquid carrier, Table 3, Comparative Example #3), neat 1,1,1,3,3-pentafluropropane (HFC245fa, as a fluorocarbon surface tension-reducing agent, Table 3, Example # 11), and coating solution formulations (sans a coating moiety) comprising mixtures of tetrafluropropanol with 25 Vol. %, 50 Vol. %, and 75 Vol. % 1,1,1,3,3-pentafluropropane (Table 3, Examples 8, 9 and 10 respectively). The surface tension exhibited by the coating solutions under the test conditions described above are presented below in Column 3 of Table 3.

TABLE 3

| | Vol. % of HFC245fa | |
|---|---|---|
| | present with | Surface Tension |
| Example # | liquid carrier* | dynes / cm² |
| Comparative Example # 3 | X | 29 |
| Example # 8 | 25% | 25 |
| Example # 9 | 50% | 21 |
| Example # 10 | 75% | 20 |
| Example # 11 | 100% | 18 |

*For all examples, the liquid carrier is tetrafluoropropanol.

The data shown in Table 3 demonstrates that there is a monotonic reduction in surface tension displayed by the coating solvent with increasing content of the 1,1,1,3,3-pentafluoropropane (HFC245fa) surface tension-reducing agent.

The next group of examples demonstrates the use of a coating solution of the present development in the preparation of optical recording media and compares such discs with optical recording media prepared using a coating solution that does not contain a volatile surface tension-reducing agent.

### Examples 12-14

### Preparation and Performance Testing of Optical Recording Discs Using Coating Solutions of the Present Development

Coating solutions from which digital optical recording discs were prepared were formulated by first mixing a coating solvent. The coating solvent was prepared by placing a measured volume of 2,2,3,3-tetrafluropropanol (liquid carrier) into a vessel and mixing in a measured volume of the HFC245fa surface tension-reducing agent (1,1,1,3,3-pentafluropropane), to give a coating solvent having the volumetric ratio of liquid carrier and surface tension-reducing agent indicated below in Table 4.

TABLE 4

| | Coating Solvent Composition | |
|---|---|---|
| | 2,2,3,3-tetrafluoropropanol | 1,1,1,3,3-Pentafluoropropane |
| | (liquid carrier) | (surface tension-reducing agent) |
| Coating Solution | (Vol %) | (Vol %) |
| Comparative Example # 4 | 100% | X |
| Example # 12 | 85% | 15% |
| Example # 13 | 75% | 25% |
| Example # 14 | 65% | 35% |

Coating solutions were prepared by dissolving into each 100 ml aliquot of the coating solvent prepared as described above, 1.8 g of cyanine dye (S0628 from Organica, used as received) and 0.18 g of a quencher (IRG022, Organica, used as received) as a light stabilizer, to produce the corresponding coating solutions identified below as Comparative Example #4 and Example Nos. 12-14, respectively. An aliquot of each of these coating solutions was examined spectroscopically for wavelength of maximum absorption (λₘₐₓ) and for extinction coefficient. These measurements were carried out on a conventional UV spectrophotometer using an aliquot of each of the coating solutions described above diluted 1 to 1,000. The UV spectroscopic measurements indicate that all solutions have approximately the same extinction coefficient and the same λₘₐₓ, indicating that the surface tension-reducing agent does not alter the optical properties of the dye.

Deposition of Dye Layers on Digital Optical Recording Discs

The coating solutions prepared as described above were used to prepare plastic discs containing a dye layer on one surface. Polycarbonate discs were moulded from Teijin polycarbonate using a Netstal Diskjet 600 moulding machine. The discs were used as moulded.

A coating was applied using a commercial spin-coating apparatus. Discs were coated with a layer of dye according to the following procedure. The temperature of the coating cabinet was controlled to 25° C.+/−1° C., and a 0.25 ml aliquot of the coating solution was sprayed on one face of the disc while it was spinning at an initial rpm. The initial spinning rate was continued until the coating solution was evenly distributed on the disc face. Spinning rate was increased stepwise to ensure a uniform dye coating was formed on the surface as the solvent evaporated from the layer of coating solution. Uniformity of the dye layer was confirmed by measuring the optical density of the coating formed on the disc with a spectrophotometer. The minimum amount of time required to form a disc having a dye layer with a thickness sufficient to yield 0.57 absorbance (Abs.) was measured for each of the above-described coating solutions. The results are presented below in Table 5.

The spin-rate increase cycle was controlled by a computer program. In a typical coating operation, the dye was dispensed at about 10 psi through a 0.2 micron filter and a 0.13 millimeter diameter nozzle with the disc to be coated spinning at about 220 rpm. After dispensing the dye, disc speed was increased in the following steps: (a) to 750 rpm and held for between about 1 and about 3 seconds; (b) to about 2100 rpm and held for between about 1 and about 3 seconds; and (c) to about 5000 rpm and held for between about 1 and about 3 seconds. Spectrophotometric measurment of the disc to insure a uniform coating of dye was accomplished using a spectrophotometer and scanning the surface. After confirming the uniformity of the dye layer the coated disc was transferred into an oven having a temperature of from about 70 to about 80 degrees C. for “curing”. The “cured” dye coating was then sputter-coated with a silver coating by published methods, then coated with lacquer (DSM 650-026 DVD lacquer) by published methods to yield 0.6 mm thick DVD-R discs. These were bonded to dummy substrates using cationic SK7020 screen print bonding adhesive (Sony) and tested as described below.

TABLE 5

| | Cycle Time Required to Form |
|---|---|
| | Uniform Dye Layer |
| Coating Solution Used | (Seconds) |
| Comparative Example # 4 | 7.5 |
| Example # 12 | 7.1 |
| Example # 13 | 6.7 |
| Example # 14 | 6.4 |

Table 5 shows that the coating solutions of the present development reduce the amount of time required to form a dye layer on an optical recording disc relative to a coating solution which contains no surface tension-reducing agent.

It was also noted during this comparison that due to the improvement in wetting of a polycarbonate disc by the coating solutions of the present development, smaller amounts of the coating solution could be applied to a disc to establish a coating solution layer of a given thickness and concomitantly requiring that less of the dye solutions be spun off of the disc after coating solution application during the portion of the coating cycle in which the coating solution is evenly distributed on the disc prior to formation of the dye layer. This reduces the amount of coating solution consumed in the production of a dye layer of a given absorbance.

Comparison of the Electrical Performance of Discs Prepared

Using Example and Comparative Example Coating Solutions

Polycarbonate discs having a dye layer prepared by spin-coating using the coating solutions of Example 12 and Example 13, as described above, were compared with discs prepared using a coating solution of Comparative Example 4. All discs were made with a dye layer sufficiently thick to give an absorbance (abs) of 0.60. Standard tests of optimum recording power, DTC Jitter, and PISum8 error were performed. It was observed that optimum recording power and DTC Jitter were comparable between the discs prepared with the various coating solutions, but that discs prepared with coating solutions of Example Nos. 12 and 13 had PISum8 error values of 75 and 70 respectively. The discs prepared from the coating solution of Comparative Example 4 displayed a PISum8 error value of 100. Though the data performance values are within acceptable ranges for a commercial recording media, the lower PISum8 error values obtained from discs having dye layers prepared using coating solutions of the present development demonstrates that the coating solutions of the present development provide a more uniform film from a dye coating process than coating solutions which do not contain the surface tension-reducing agent of the present development.

### Examples 15 and 16

### Discs Prepared With Coating Solutions Containing HFC365 mfc Surface Tension Reducing Agent

In this example, discs were prepared using coating solutions comprising Organica 967 cyanine dye dissolved in 2,2,3,3 tetrafluoropropanol (a standard solvent used in the preparation of DVD dye-coating solutions) with the amounts of 1,1,1,2,2 pentafluorobutane (HFC365mfc) surface tension-reducing agent shown in Table 6. These coating solutions were prepared using the above-described procedure. Since the dye used in the coating solution contained a quencher, no additional quencher was needed in the coating solutions.

TABLE 6

| | Volume % Solvent | Volume % Surface Tension- | |
|---|---|---|---|
| Coating | (2,2,3,3- | reducing Agent HFC 365mfe | Wt. % Dye |
| Solution | Tetrafluoropropanol) | (1,1,1,2,2 pentafluorobutane) | (Organica 967) |
| Comparative | 100 | 0 | 2.0 |
| Example # 5 | | | |
| Example # 15 | 80 | 20 | 2.0 |
| Example # 16 | 60 | 40 | 1.5 |

Using the above-described procedure, the coating solutions of Table 6 were used to apply coatings to standard DVD-R 02087102 substrates having optical absorbance density of either 0.54, 0.56, or 0.58 abs. (measured spectrophometrically, as described above). It was observed that coatings of these optical densities could not be prepared using a 2 wt. % dye coating solution based on the 60/40 mixture coating solvent (60 Vol. % liquid carrier and 40 Vol. % surface tension reducing agent) because the coating solution was too concentrated in the coating moiety. Accordingly, when the 60/40 mixture coating solvent was used a more dilute 1.5 wt. % dye solution was prepared for coating test discs.

It was observed that the coating solutions which contained the surface tension-reducing agent had lower viscosity than the coating solution prepared from 100 Vol. % 2,2,3,3-tetrafluoropropanol. This was reflected in the lower line pressure required for application of the coating solutions of Examples 15 and 16 (8 psi) compared with Comparative Example 5 (12 psi).

The amount of cycle time required to prepare coatings was recorded for each solution, as described above, and the result for these examples is reported in Table 7. These data show that for dye layers having less than 0.58 Abs, the two coating solutions containing 1,1,1,2,2-pentafluorobutane (HFC365mfc) display a reduced amount of time required to form the dye layer on an optical recording disc when compared to a coating solution which contains no surface tension-reducing agent.

TABLE 7

| | Cycle Time Required to | | |
|---|---|---|---|
| | Form Uniform Dye Layer (Seconds) | | |
| Coating Solution Used | 0.54 Abs | 0.56 Abs | 0.58 Abs |
| Comparative Example # 5 | 7.35 | 7.38 | 7.41 |
| Example # 15 | 5.9 | 6.2 | 7.2 |
| Example # 16 | 6.2 | 7.0 | 7.5 |

The time required to apply a 0.58 Abs. coating using the 60/40 mixture coating solvent in comparison to the time required for deposition of a coating from a coating solvent comprising tetrafluoropropanol alone should be considered in view of the fact that the coating solution employing the 60/40 mixture was a much less concentrated dye solution than the solution containing only tetrafluoropropanol, requiring a larger volume of the solution layer to be to achieve the same optical density. Accordingly, the faster cycle times observed for the less optically dense coatings is even more significant.

The groove-filling properties of the coatings solutions described in Table 6 were compared by using atomic force microscopy to measure the thickness of the dye coating of the coated discs. These data are shown in Table 8, and indicate that the groove-filling properties of coating solutions containing the surface tension-reducing agent are comparable to those of the coating solution prepared without a surface tension-reducing agent.

TABLE 8

| | Groove Filling (nanometers) | | |
|---|---|---|---|
| Example No. | 0.54 Abs | 0.56 Abs | 0.58 Abs |
| Comparative Example # 5 | 109.49 | 108.14 | |
| Example # 15 | 110.89 | 109.06 | |
| Example # 16 | 109.62 | 107.38 | 106.5 |

It was also noted that the dye solutions containing the volatile surface tension-reducing agent could be left to stand in the spray head of the coating apparatus for periods of up to an hour without the dye crystallizing our of solution and blocking the outlet of the spray head.

Discs of Comparative Example 5, and of Examples 15 and 16 were electrically compared using an Audio Developments DVD-rite® and DVD-pro® testing equipment in accordance with known procedures. It was observed that all of the coated discs had satisfactory electrical performance.

In summary, the data of Examples 15 and 16 show that in the provision of discs having comparable properties in comparison with discs prepared using art-recognized coating solutions, the coating solutions of the present development provide for application of a coating layer of a given thickness using a smaller volume of the coating solution and concomitantly require that less coating solution be spun off of the disc after coating solution application during the portion of the coating cycle in which the coating solution is evenly distributed on the disc prior to formation of the dye layer. This reduces the amount of coating solution consumed in the production of a dye layer of a given absorbance.

What is claimed is:

1. A composition comprising: (i) a coating solvent comprising a liquid carrier, and at least one fluorocarbon surface tension-reducing agent; and (ii) a coating moiety dissolved therein.

2. The composition of claim 1 wherein the fluorocarbon is an about 3 to about 8 carbon atom liner, branched, or cyclic, saturated or unsaturated aliphatic compound having at least one fluorine atom bonded to a carbon atom thereof.

3. The composition of claim 1 wherein the liquid carrier comprises one or more fluorinated alcohols selected from the group consisting of alcohols having from about 3 to about 7 carbon atoms and from about 1 to about 13 fluorine atoms.

4. The composition of claim 2 wherein the fluorocarbon is selected from the group consisting of 1,1,1,3,3-pentafluoropropane (HFC245fa), 1,1,1,2,2-pentafluorobutane (HFC365mfc) and mixtures thereof.

5. The composition of claim 1, wherein said coating solvent comprises:
(i) a liquid carrier present in an amount up to about 99 vol. %; and
(ii) from about 1 Vol. % to about 75 Vol. % of said fluorocarbon surface tension-reducing agent;
and wherein the coating solvent has dissolved therein up to about 10 wt. % of a coating moiety.

6. The composition of claim 5 wherein the liquid carrier is 2,2,3,3-tetrafluoropropanol.

7. The composition of claim 6 wherein the liquid carrier is present to a level of at least about 60 vol. %.

8. The composition of claim 5, wherein the surface tension-reducing agent is 1,1,1,3,3-pentafluoropropane (HFC245fa) and is present to a level of no greater than about 25 vol. %.

9. The composition of claim 5, wherein the surface tension-reducing agent is 1,1,1,2,2-pentafluorobutane (HFC365mfc) and is present to a level of no greater than about 40 vol. %.

10. The composition of claim 8, wherein the surface tension reducing agent is present to a level of about 20 vol. % and the coating solution has dissolved therein from about 1 wt. % to about 2 wt. % of a coating moiety.

11. The composition of claim 5, wherein the liquid carrier is 2,2,3,3,4,5,5-octafluoropentanol.

12. The composition of claim 6 further comprising as a liquid carrier up to 50 vol % octafluoropentanol.

13. A method of applying a layer of a film-forming coating moiety to a surface of a substrate comprising applying a coating of a composition of claim 1 to said substrate surface and removing said liquid carrier and said surface tension-reducing agent from said coating.

14. The method of claim 13, wherein said coating is formed from a coating solution applied to said substrate surface by spin coating.

15. The method of claim 13, wherein said coating is formed from a coating solution applied to said substrate surface by dip coating.

16. A surface coating prepared by the method of claim 13.
